(19) United States
(12) Patent Application Publication
(10) Pub. No.: US 2026/0135622 A1
(43) Pub. Date: May 14, 2026

(54) METHODS AND APPARATUS FOR DISTRIBUTING QUANTUM-ENTANGLED PAIRS BETWEEN COMMUNICATION NODES

(71) Applicant: TECHNISCHE UNIVERSITEIT DELFT, DELFT (NL)

(72) Inventors: Johannes BORREGAARD, DELFT (NL); Yunzhe ZHENG, DELFT (NL)

(21) Appl. No.: 19/121,776

(22) PCT Filed: Oct. 20, 2023
(86) PCT No.: PCT/NL2023/050553

§ 371 Date: Apr. 16, 2025

(30) Foreign Application Priority Data
Oct. 21, 2022 (NL) 2033371

(51) Int. Cl. H04B 10/70

(52) U.S. Cl. CPC H04B 10/70

(57) ABSTRACT

The first node 101 performs a method for distributing a plurality of quantum-entangled pairs 110 between a plurality of nodes 101, 102 in a communication network; the method comprising, at a first node 101 of the plurality of nodes: generating 111 a qudit of dimension 2^{m}, m being an integer greater than 1, in such a manner that the qudit is entangled with a first memory 121 at the first node 101; transmitting 112 the entangled qudit to a second node 102 of the plurality of nodes; and receiving 132 a heralding acknowledgement from the second node 102 that the transmitted qudit has been entangled with a second memory 122 at the second node 102; wherein a memory state of the first memory 121 is maintained after entangling the qudit at least until the heralding acknowledgement is received 132.

### TECHNICAL FIELD

The present disclosure generally relates to the field of quantum communication, and in particular to entanglement distribution in quantum networks, which underlies functionalities such as distributed/cloud quantum computing, device-independent quantum key distribution and distributed quantum sensing. Particular embodiments relate to methods and apparatus for distributing a plurality of quantum-entangled pairs between a plurality of nodes in a communication network.

### BACKGROUND

Quantum entanglement refers to distinct quantum systems being entangled, i.e. linked, in such a way that their joint behavior is correlated more strongly than allowed by classical physics. When such quantum systems are used as carriers of quantum information they are usually referred to as quantum bit or qubit systems. Quantum entanglement can thus be a nonlocal property of two or more qubits, which among other things, allows for the teleportation of quantum information by means of local measurements and transmission of only classical information, thereby circumventing the need to transmit quantum information directly between distant qubit systems.

The ability to faithfully transmit quantum information over long distance is a key prerequisite for the construction of large-scale quantum networks, which bring new opportunities for secure communication, distributed sensing, and scalable quantum computing. As such, there have been significant efforts for creating entanglement between remote qubit systems across a plethora of physical systems including trapped ions, diamond defect centers, neutral atoms and quantum dots.

In conventionally known entanglement generation protocols, spin-photon entanglement is first created and then extended to spin-spin entanglement by either a photonic Bell measurement or a direct spin-photon interaction. Successful entanglement generation is heralded by the detection of transmitted photons, and the quantum state of the spin qubits needs to stay coherent for at least the time of one entanglement generation attempt, which is generally set by the signaling time between the nodes.

Key functionalities in a quantum network such as entanglement purification and multi-qubit state teleportation require the availability of more than a single entangled qubit pair to be executed. The latter, in particular, when quantum information encoded across multiple physical qubits in a quantum error correcting code has to be transmitted, since all physical qubits of the code have to be transmitted simultaneously in order to perform error correction locally.

Known approaches of generating multiple entangled qubit pairs operate either sequentially or in parallel using the same photonic qubit-based protocols as for the generation of a single entangled qubit pair. High transmission loss, however, leads to much more demanding requirements for the coherence time of the qubits than for the single pair setup. For a feasible generation rate, successfully entangled pairs have to be stored in quantum memories while they wait for remaining pairs to entangle successfully. As a result, the required memory time increases as the inverse of the photon transmission probability, which decreases exponentially with the distance between the nodes for standard optical fiber propagation. To add insult to injury, the continued entanglement attempts of neighboring qubits may further decrease the memory time of a successful pair due to unwanted crosstalk.

### SUMMARY

The inventors have identified that the above-described approach suffers at least from a problem of stringent memory requirements for feasible generation rates. In particular, in the above-described approach it is necessary to maintain the memory at the parties intending to communicate (one party may arbitrarily be named Alice and the other party Bob, but it will be appreciated that this naming is entirely illustrative and moreover that the roles of Alice and Bob may be interchanged) for a long enough time for the required number of available entangled qubit pairs as dictated by the specific application (e.g. multi-state teleportation or entanglement purification) to be separately set up.

This is due to the need for repeated single attempts to generate multiple entangled pairs either sequentially or in parallel using the same photonic qubit-based protocols as for the generation of a single entangled pair. In essence, the above-described approach requires that qubit coherence at Alice and Bob for already successfully generated qubit pairs can be maintained for a time that is sufficient for successfully setting up the remaining of the required entangled pairs as dictated by the specific application. Note that this strictly applies to any application where more than one entangled pair is required.

It is an insight of the inventors to mitigate these stringent memory requirements, not only at Alice but also at Bob.

Accordingly, the inventors have sought to overcome the above-described problems.

In a first aspect of the present disclosure, there is provided a method for distributing a plurality of quantum-entangled pairs between a plurality of nodes in a communication network. The method comprises, at a first node of the plurality of nodes: generating a qudit of dimension 2^{m}, m being an integer greater than 1, in such a manner that the qudit is entangled with a first memory at the first node; transmitting the entangled qudit to a second node of the plurality of nodes; and receiving a heralding acknowledgement from the second node that the transmitted qudit has been entangled with a second memory at the second node. A memory state of the first memory is maintained after entangling the qudit at least until the heralding acknowledgement is received.

Note that the term distributing may in general mean to give out, usually in shares, to each member of a group. Note in particular that the term distributing may imply an apportioning by separation of something into parts, units, or amounts. In a practical setting, the expression “distributing a plurality of quantum-entangled pairs between a plurality of nodes in a communication network” may mean that each respective first element of the plurality of quantum-entangled pairs (i.e. the first one of each pair) is provided to one node and each respective second element of the plurality of quantum-entangled pairs (i.e. the second one of each pair) is provided to another node. In this sense, each individual pair of the plurality of quantum-entangled pairs is distributed between the nodes. Thus, the one qudit by itself does not comprise the plurality of quantum-entangled pairs, but only becomes quantum-entangled by entangling it at the one node and entangling it at the other node.

The nodes of the communication network may be distinct, remote systems involved in inter-system communication over a distance. Alternatively, the nodes of the communication network may be separate parts of an integral system, each belonging to that integral system, and thus implementing intra-system (e.g. inter-process) communication.

In either case, it is advantageous for the nodes of the communication network to agree beforehand (i.e. prior to executing the method according to the present disclosure) on the details of the protocol to use, including but not limited to: synchronization or other timing arrangements, and/or the expected cardinality of the qudit (i.e. the value of the integer m). It is noted that after this prior agreement, there is no further need of alignment or communication for the steps of generating and entangling (although such alignment or communication may of course still be allowed), until the exchange of the qudit and the exchange of the heralding acknowledgement, which ascertains that a plurality of quantum-entangled pairs has been distributed between the plurality of nodes of the communication network.

In a second aspect of the present disclosure, there is provided a method for distributing a plurality of quantum-entangled pairs between a plurality of nodes in a communication network. The method comprises, at a second node of the plurality of nodes: obtaining a qudit of dimension 2^{m}, m being an integer greater than 1, wherein the qudit has been generated by a first node of the plurality of nodes; entangling the qudit with a second memory at the second node; and transmitting a heralding acknowledgement to a third node of the plurality of nodes or to the first node that the obtained qudit has been entangled with the second memory. A memory state of the second memory is maintained after entangling the qudit at least until the heralding acknowledgement is received.

In some embodiments of the method according to the second aspect of the present disclosure, the qudit has been entangled with a first memory at the first node of the plurality of nodes; and the heralding acknowledgement is transmitted to the first node.

In some further developed embodiments of the method according to the second aspect of the present disclosure, the method comprises, at the second node: obtaining another qudit of dimension 2^{m}, m being an integer greater than 1, wherein the other qudit has been entangled with a fourth memory at a fourth node of the plurality of nodes; entangling the other qudit with the second memory; and transmitting another heralding acknowledgement to the fourth node that the obtained other qudit has been entangled with the second memory. The memory state of the second memory is maintained after entangling the other qudit at least until the other heralding acknowledgement is received.

Note that the naming of the “fourth” node does not impose that there must necessarily be a “third” node; in some embodiments, there may be a first node, a second node, and a fourth node, but no third node, e.g. as in the embodiment of FIG. 2A or FIG. 2B. Obviously, for those embodiments, if the heralding acknowledgement is transmitted “to a third node of the plurality of nodes or to the first node”, the skilled person will effortlessly interpret this in the sense that the heralding acknowledgement is transmitted to the first node, given that those embodiments may lack such a third node.

Of course, the specific order in which the qudit and the other qudit are obtained and entangled with the second memory is of no consequence-that is, the qudit may be entangled with the first memory first, before the other qudit is entangled with the memory, or vice versa, or the qudit and the other qudit may even be entangled with the memory simultaneously.

In some embodiments of any one of the preceding methods according to the present disclosure, the first memory and the second memory each comprise a memory register of m qubits.

In some embodiments of any one of the preceding methods according to the present disclosure, the method comprises: at the first node, if no heralding acknowledgement is received from the second node within a predetermined timeframe, attempting to distribute a plurality of quantum-entangled pairs anew. Alternatively or additionally, the method comprises: at the second node, if the qudit or the other qudit has failed to be entangled with the second memory, transmitting a failure notification to the first node or the fourth node, triggering the first node or the fourth node to attempt distributing a plurality of quantum-entangled pairs anew.

In some embodiments of any one of the preceding methods according to the present disclosure, the qudit is a quantum particle selected from the following: a photon; an electron; an ion; and a phonon; and the qudit is preferably a photon.

Note that if some fundamental characteristic (e.g. the type of quantum particle that it is) applies to the qudit, then the skilled person will understand that the same fundamental characteristic may apply to the other qudit for certain embodiments.

In some embodiments of any one of the preceding methods according to the present disclosure, entangling the qudit with a memory comprises time-bin encoding the qudit in m time-bins; and the step of time-bin encoding the qudit in m time-bins preferably comprises routing the qudit, being a photon, via a plurality of optical switches, to a corresponding plurality of spin-cavity systems corresponding with a desired binary encoding of the time-bins.

In some embodiments of any one of the preceding methods according to the present disclosure, the qudit is a photon and the qudit is generated using at least one single quantum emitter (e.g. a neutral atom or a diamond defect center) coupled to at least one optical resonator.

In some embodiments of any one of the preceding methods according to the present disclosure, the qudit is a photon and the qudit is generated by means of a pulsed, cavity-assisted Raman scheme.

In a third aspect of the present disclosure, there is provided a computer-readable storage medium comprising computer program instructions configured for, when executed by at least one processor of a node of a communication network, cause the node to perform the method of any one of the preceding embodiments.

In a fourth aspect of the present disclosure, there is provided a first node in a communication network containing a plurality of nodes, for distributing a plurality of quantum-entangled pairs between the plurality of nodes. The first node comprises: a first memory; a qudit generator configured for generating a qudit of dimension 2^{m}, m being an integer greater than 1, in such a manner that the qudit is entangled with the first memory; a qudit transmitter configured for transmitting the entangled qudit to a second node of the plurality of nodes; and a receiver configured for receiving a heralding acknowledgement from the second node that the transmitted qudit has been entangled with a second memory at the second node. The first memory is configured to maintain its memory state after entangling the qudit at least until the heralding acknowledgement is received.

In a fifth aspect of the present disclosure, there is provided a second node in a communication network containing a plurality of nodes, for distributing a plurality of quantum-entangled pairs between the plurality of nodes. The second node comprises:

a qudit receiver configured for obtaining a qudit of dimension 2^{m}, m being an integer greater than 1, wherein the qudit has been generated by a first node of the plurality of nodes; a qudit entangler configured for entangling the qudit with a second memory at the second node; and a transmitter configured for transmitting a heralding acknowledgement to a third node of the plurality of nodes or to the first node that the obtained qudit has been entangled with the second memory. The second memory is configured to maintain its memory state after entangling the qudit at least until the heralding acknowledgement is received.

In some embodiments of the second node according to the present disclosure, the qudit has been entangled with a first memory at the first node of the plurality of nodes; and the transmitter is configured for transmitting the heralding acknowledgement to the first node.

In some further developed embodiments of the second node according to the present disclosure, the qudit receiver is configured for obtaining another qudit of dimension 2^{m}, m being an integer greater than 1, wherein the other qudit has been entangled with a fourth memory at a fourth node of the plurality of nodes; the qudit entangler is configured for entangling the other qudit with the second memory; the transmitter is configured for transmitting another heralding acknowledgement to the fourth node that the obtained other qudit has been entangled with the second memory; and the second memory is configured to maintain its memory state after entangling the other qudit at least until the other heralding acknowledgement is received.

### BRIEF DESCRIPTION OF THE DRAWINGS

The above embodiments are intended merely to illustrate in a non-limiting manner the present invention, which will be more fully understood with the help of the following description and appended drawings, in which:

FIG. 1 schematically illustrates an embodiment of a first node as well as an embodiment of a second node according to the present disclosure, performing two respective method embodiments according to the present disclosure;

FIG. 2A schematically illustrates two embodiments of a first node as well as an embodiment of a second node according to the present disclosure, performing three respective method embodiments according to the present disclosure;

FIG. 2B schematically illustrates a variant of the situation of FIG. 2A; and

FIG. 3 schematically illustrates two embodiments of a second node according to the present disclosure, performing two respective method embodiments according to the present disclosure.

### DETAILED DESCRIPTION

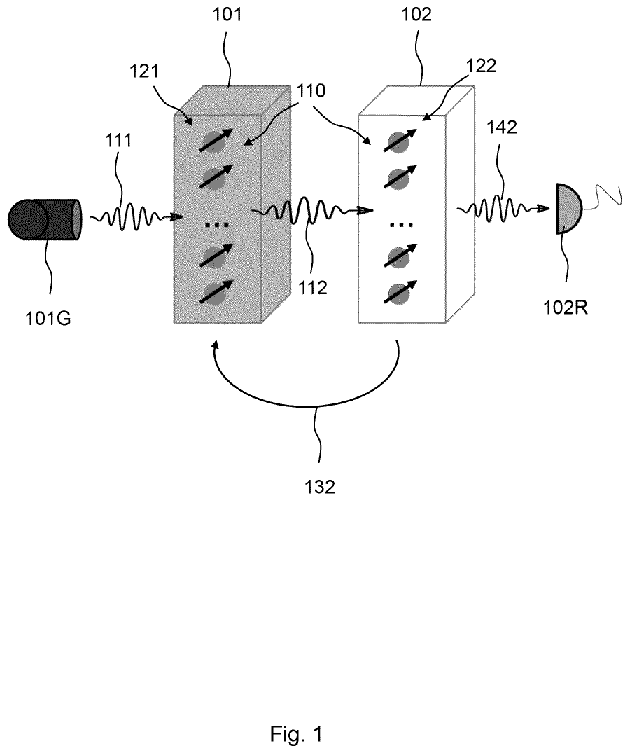

FIG. 1 schematically illustrates an embodiment of a first node as well as an embodiment of a second node according to the present disclosure, performing two respective method embodiments according to the present disclosure.

The figure shows a communication network comprising a first node 101, which may conveniently and without loss of generality be called Alice, and a second node 102, which may conveniently and without loss of generality be called Bob. Of course, it will be understood that the names Alice and Bob are for convenience only, and are not intended to be limiting in any manner.

Alice in FIG. 1—The first node 101 (i.e. Alice) may serve for distributing a plurality of quantum-entangled pairs 110 between the plurality of nodes, in the sense that it is on the sending end. The first node may comprise: a first memory 121; a qudit generator (a photon source 101G is shown, which may serve as a qudit generator) configured for generating 111 (represented as the wave exiting photon source 101G) a qudit of dimension 2^{m}, m being an integer greater than 1, in such a manner that the qudit is entangled with the first memory 121; a qudit transmitter (not shown, but implicit in the start of wave 112) configured for transmitting 112 the entangled qudit to a second node 102 of the plurality of nodes; and a receiver (not shown, but implicit in the end of heralding acknowledgement 132) configured for receiving 132 a heralding acknowledgement from the second node 102 that the transmitted qudit has been entangled with a second memory 122 at the second node 102. The first memory 121 is configured to maintain its memory state after entangling the qudit at least until the heralding acknowledgement is received 132.

Consequently, the first node 101 (i.e. Alice) performs a method for distributing a plurality of quantum-entangled pairs 110 between a plurality of nodes 101, 102 in a communication network; the method comprising, at a first node 101 of the plurality of nodes: generating 111 a qudit of dimension 2^{m}, m being an integer greater than 1, in such a manner that the qudit is entangled with a first memory 121 at the first node 101; transmitting 112 the entangled qudit to a second node 102 of the plurality of nodes; and receiving 132 a heralding acknowledgement from the second node 102 that the transmitted qudit has been entangled with a second memory 122 at the second node 102; wherein a memory state of the first memory 121 is maintained after entangling the qudit at least until the heralding acknowledgement is received 132.

Bob in FIG. 1—The second node 102 may also serve for distributing the plurality of quantum-entangled pairs 110 between the plurality of nodes, in the sense that it is on the receiving end. The second node may comprise: a qudit receiver (not shown, but implicit in the end of wave 112) configured for obtaining 112 a qudit of dimension 2^{m}, m being an integer greater than 1, wherein the qudit has been generated 111 by the first node 101 of the plurality of nodes, and more in particular the qudit has been entangled with a first memory 121 at the first node 101; a qudit entangler (not shown) configured for entangling the qudit with a second memory 122 at the second node 102; and a transmitter (not shown, but implicit in the start of heralding acknowledgement 132) configured for transmitting 132 a heralding acknowledgement to the first node 101 that the obtained qudit has been entangled with the second memory 122. The second memory 122 is configured to maintain its memory state after entangling the qudit at least until the heralding acknowledgement is received 132.

Consequently, the second node 102 (i.e. Bob) performs a method for distributing a plurality of quantum-entangled pairs 110 between a plurality of nodes 101, 102 in a communication network; the method comprising, at a second node 102 of the plurality of nodes: obtaining 112 a qudit of dimension 2^{m}, m being an integer greater than 1, wherein the qudit has been generated 111 by a first node 101 of the plurality of nodes, and more in particular the qudit has been entangled with a first memory 121 at the first node 101; entangling the qudit with a second memory 122 at the second node 102; and transmitting 132 a heralding acknowledgement to the first node 101 that the obtained qudit has been entangled with the second memory 122; wherein a memory state of the second memory is maintained after entangling the qudit at least until the heralding acknowledgement is received 132.

Moreover, in this specific example, the second node 102 (i.e. Bob) may be coupled to a generalized X-basis qudit measurement device 102R for measuring 142 the qudit, preferably without collapsing the state of the memories involved. Of course, depending on the type of quantum particle that is used, photon source 101G and generalized X-basis qudit measurement device 102R are optional. Just as an example, the qudit may be a quantum particle selected from the following: a photon; an electron; an ion; and a phonon. Preferably, the qudit is a photon.

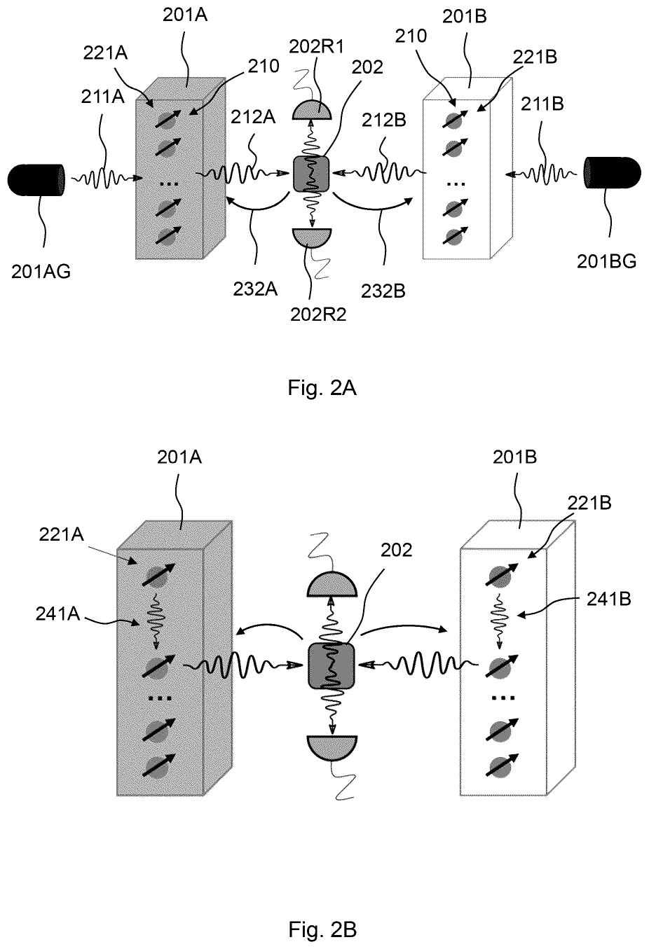

FIG. 2A schematically illustrates two embodiments of a first node as well as an embodiment of a second node according to the present disclosure, performing three respective method embodiments according to the present disclosure.

The figure shows a communication network comprising a first node 201A, which may conveniently and without loss of generality be called Alice, and another second node 201B, which may conveniently and without loss of generality be called Bob. Of course, it will be understood that the names Alice and Bob are for convenience only, and are not intended to be limiting in any manner. The figure further shows a second node 202, which may be considered a relay node and is preferably situated midway (preferably in terms of propagation time) between Alice 201A and Bob 201B.

Alice in FIG. 2A—Alice is a first node 201A in a communication network containing a plurality of nodes 201A, 201B, 202, and may serve for distributing a plurality of quantum-entangled pairs 210 between the plurality of nodes in the sense that it is on the sending end. First node Alice 201A may comprise: a first memory 221A; a qudit generator (a photon source 201AG is shown, which may serve as a qudit generator) configured for generating 211A (represented as the wave 211A exiting photon source 201AG) a qudit of dimension 2^{m}, m being an integer greater than 1, in such a manner that the qudit is entangled with the first memory 221A; a qudit transmitter (not shown, but implicit in the start of wave 212A) configured for transmitting the entangled qudit to a second node 202 of the plurality of nodes; and a receiver (not shown, but implicit in the end of heralding acknowledgement 232A) configured for receiving 232A a heralding acknowledgement from the second node 202 that the transmitted qudit has been entangled with a second memory (not shown) at the second node 202. The first memory 221A is configured to maintain its memory state after entangling the qudit at least until the heralding acknowledgement is received 232A.

Bob in FIG. 2A—Bob also is a first node 201B in the communication network containing the plurality of nodes 201A, 201B, 202, and may serve for distributing a plurality of quantum-entangled pairs 210 between the plurality of nodes in the sense that it is on the sending end. First node Bob 201B may comprise: a first memory 221B; a qudit generator (a photon source 201BG is shown, which may serve as a qudit generator) configured for generating 211B a qudit of dimension 2^{m}, m being an integer greater than 1, in such a manner that the qudit is entangled with the first memory; a qudit transmitter (not shown, but implicit in the start of wave 212B) configured for transmitting the entangled qudit to a second node 202 of the plurality of nodes; and a receiver (not shown, but implicit in the end of heralding acknowledgement 232B) configured for receiving 232B a heralding acknowledgement from the second node that the transmitted qudit has been entangled with a second memory (not shown) at the second node 202. The first memory 221B is configured to maintain its memory state after entangling the qudit at least until the heralding acknowledgement is received 232B.

Alice and Bob in FIG. 2A—Consequently, both first node Alice 201A and first node Bob 201B perform a method for distributing a plurality of quantum-entangled pairs 210 between a plurality of nodes 201A, 201B, 202 in a communication network; the method comprising, at a first node 201A, 201B of the plurality of nodes: generating 211A, 211B a qudit of dimension 2^{m}, m being an integer greater than 1, in such a manner that the qudit is entangled with a first memory 221A, 221B at the first node; transmitting 212A, 212B the entangled qudit to a second node 202 of the plurality of nodes; and receiving 232A, 232B a heralding acknowledgement from the second node 202 that the transmitted qudit has been entangled with a second memory at the second node 202; wherein a memory state of the first memory 221A, 221B is maintained after entangling the qudit at least until the heralding acknowledgement is received 232A, 232B.

Relay in FIG. 2A—The second node 202 in the communication network containing the plurality of nodes 201A, 201B, 202, may also serve for distributing a plurality of quantum-entangled pairs (110; 210; 310) between the plurality of nodes, in the sense that it is on the receiving end. The second node 202 may comprise: a qudit receiver (not shown, but implicit in the end of wave 212A) configured for obtaining 212A a qudit of dimension 2^{m}, m being an integer greater than 1, wherein the qudit has been generated 211A by a first node 201A of the plurality of nodes, and more in particular the qudit has been entangled with a first memory 221A at the first node 201A; a qudit entangler (not shown) configured for entangling the qudit with a second memory (not shown) at the second node 202; and a transmitter (not shown, but implicit in the start of heralding acknowledgement 232A) configured for transmitting 232A a heralding acknowledgement to the first node 201A that the obtained qudit has been entangled with the second memory. The second memory is configured to maintain its memory state after entangling the qudit at least until the heralding acknowledgement is received.

Moreover, the qudit receiver of the second node 202 may be configured for obtaining 212B another qudit of dimension 2^{m}, m being an integer greater than 1, wherein the other qudit has been entangled with a fourth memory 221B at a fourth node 201B of the plurality of nodes; the qudit entangler may be configured for entangling the other qudit with the second memory;
the transmitter may be configured for transmitting 232B another heralding acknowledgement to the fourth node 201B that the obtained other qudit has been entangled with the second memory; and the second memory may be configured to maintain its memory state after entangling the other qudit at least until the other heralding acknowledgement is received.

Consequently, the second node 202 (i.e. the relay node) performs a method for distributing a plurality of quantum-entangled pairs 210 between a plurality of nodes 201A, 201B, 202 in a communication network; the method comprising, at a second node 202 of the plurality of nodes: obtaining 212A a qudit of dimension 2^{m}, m being an integer greater than 1, wherein the qudit has been generated 211A by a first node 201A of the plurality of nodes, and more in particular the qudit has been entangled with a first memory 221A at the first node 201A; entangling the qudit with a second memory at the second node 202; and transmitting 232A a heralding acknowledgement to the first node 201A that the obtained qudit has been entangled with the second memory;
wherein a memory state of the second memory is maintained after entangling the qudit at least until the heralding acknowledgement is received.

Moreover, the method comprises, at the second node 202: obtaining 212B another qudit of dimension 2^{m}, m being an integer greater than 1, wherein the other qudit has been entangled with a fourth memory 221B at a fourth node 201B (i.e. first node Bob 201B of the above-described method) of the plurality of nodes; entangling the other qudit with the second memory; and transmitting 232B another heralding acknowledgement to the fourth node 201B that the obtained other qudit has been entangled with the second memory (in this context, heralding acknowledgement 232B is “another” heralding acknowledgement than heralding acknowledgement 232A, because it is directed to another node, namely to first node Bob 201B, i.e. the fourth node, instead of to first node Alice 201A); wherein the memory state of the second memory is maintained after entangling the other qudit at least until the other heralding acknowledgement is received 232B.

It will be clear from the setup shown in FIG. 2A and from the accompanying description above, that Bob 201B is of course a first node 201B from his own perspective (i.e. in the method at the sending end), and at the same time is a fourth node 201B from the perspective of the relay node 202 (i.e. in the method at the receiving end).

From the perspective of the second node 202 (i.e. the relay node), Alice and Bob are of course distinct entities but they operate in an analogous manner because they follow the same (or a compatible) communication protocol with the second node 202.

Note that the naming of the “fourth” node does not impose that there must necessarily be a “third” node; in some embodiments, there may be a first node, a second node, and a fourth node, but no third node, e.g. as in the embodiment of FIG. 2A or FIG. 2B. Obviously, for those embodiments, if the heralding acknowledgement is transmitted “to a third node of the plurality of nodes or to the first node”, the skilled person will effortlessly interpret this in the sense that the heralding acknowledgement is transmitted to the first node, given that those embodiments may lack such a third node.

Moreover, in this specific example, the second node 202 (i.e. the relay node) may be coupled to generalized X-basis qudit measurement devices 202R1, 202R2 for measuring the qudit and the other qudit, preferably without collapsing the state of the memories involved. Of course, depending on the type of quantum particle that is used, photon sources 201AG and 201BG as well as generalized X-basis qudit measurement devices 202R1 and 202R2 are optional.

If no relay is used, like in FIG. 1, the time to herald, thus the time to confirm successful entanglement, is equal to the single-trip time from Bob to Alice, as the heralding acknowledgement needs to be propagated from Bob to Alice.

The benefit of using a relay between Alice and Bob is that the time to herald is less than the single-trip time between both nodes, as the heralding acknowledgement only needs to be propagated from the relay to the nodes. Advantageously, the relay may be chosen midway or approximately midway between Alice and Bob, such that the time to herald is only half the single-trip time between both nodes. Otherwise, if the relay is chosen closer to one of the two nodes, the time to herald is shorter for the closer node but longer for the node farther away from the relay.

Of course, if a relay is used, both Alice and Bob may generate, entangle and transmit their qudit separately, though not independently, as Alice and Bob may agree on a mutual synchronization, to ensure that their respective first register and second register have a long enough memory time limit.

FIG. 2B schematically illustrates a variant of the situation of FIG. 2A. FIG. 2B largely corresponds with FIG. 2A, except in that one or more of the nodes (in this particular example both nodes) may comprise a differently implemented combination of qudit generator 241A, 241B and memory 221A, 221B. Specifically, the generation of the qudit is in this implementation not a separate action from the generation of the spin-photon entanglement. Instead, the qudit is generated by emission from the memory register in such a way that the emission of the photon in a specific timebin is correlated with the state of the qubit register. This can e.g. be done through selective excitation of a quantum emitter dependent on the state of the qubit register.

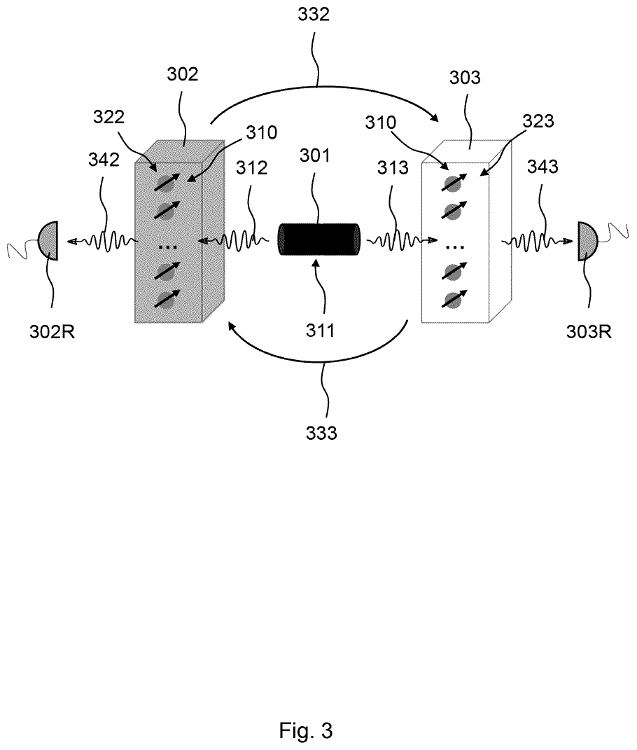

FIG. 3 schematically illustrates two embodiments 302, 303 of a second node according to the present disclosure, performing two respective method embodiments according to the present disclosure.

Alice and Bob in FIG. 3—The figure shows a second node Alice 302 in a communication network containing a plurality of nodes 301, 302, 303, which may serve for distributing a plurality of quantum-entangled pairs 310 between the plurality of nodes, in the sense that Alice is at the receiving end. The second node Alice 302 comprises: a qudit receiver (not shown, but implicit in the end of wave 312) configured for obtaining 312 a qudit of dimension 2^{m}, m being an integer greater than 1, wherein the qudit has been generated 311 by a first node 301 of the plurality of nodes; a qudit entangler (not shown) configured for entangling the qudit with a second memory 322 at the second node 302; and a transmitter (not shown, but implicit in the start of heralding acknowledgement 332) configured for transmitting 332 a heralding acknowledgement to a third node 303 of the plurality of nodes that the obtained qudit has been entangled with the second memory 322. The second memory 322 is configured to maintain its memory state after entangling the qudit at least until the heralding acknowledgement is received 332 (by the third node 303, i.e. second node Bob 303).

The figure also shows a second node Bob 303 in the communication network containing the plurality of nodes 301, 302, 303. Bob too may serve for distributing the plurality of quantum-entangled pairs 310 between the plurality of nodes, in the sense that Bob is at the receiving end. The second node Bob 303 comprises: a qudit receiver (not shown, but implicit in the end of wave 313) configured for obtaining 313 a qudit of dimension 2^{m}, m being an integer greater than 1, wherein the qudit has been generated 311 by a first node 301 of the plurality of nodes; a qudit entangler (not shown) configured for entangling the qudit with a second memory 323 at the second node 303; and a transmitter (not shown, but implicit in the start of heralding acknowledgement 333) configured for transmitting 333 a heralding acknowledgement to a third node 302 (i.e. second node Alice 202) of the plurality of nodes that the obtained qudit has been entangled with the second memory 323; wherein the second memory 323 is configured to maintain its memory state after entangling the qudit at least until the heralding acknowledgement is received 333 (by the third node 302, i.e. second node Alice 302).

Alice and Bob in FIG. 3—Consequently, both second node Alice 302 and second node Bob 303 perform a method for distributing a plurality of quantum-entangled pairs 310 between a plurality of nodes 301, 302, 303 in a communication network; the method comprising, at a second node 302, 303 of the plurality of nodes: obtaining 312, 313 a qudit of dimension 2^{m}, m being an integer greater than 1, wherein the qudit has been generated 311 by a first node 301 of the plurality of nodes; entangling the qudit with a second memory 322, 323 at the second node 302, 303; and transmitting 332, 333 a heralding acknowledgement to a third node 303, 302 of the plurality of nodes that the obtained qudit has been entangled with the second memory 322, 323; wherein a memory state of the second memory is maintained after entangling the qudit at least until the heralding acknowledgement is received 332, 333.

Qudit generator in FIG. 3—Now will be discussed the first node 301, which functions as a qudit generator for generating 311 qudits. It is to be understood that first node 301 merely exemplifies a context for embodiments according to the present disclosure, such as second node Alice 302 and second node Bob 303, for example. The first node 301 may preferably be situated midway (preferably in terms of propagation time) between second node Alice 302 and second node Bob 303. The first node 301 may be configured for generating 311 a first qudit of dimension 2^{m}, m being an integer greater than 1, and a second qudit of dimension 2^{m}, m being an integer greater than 1, in such a manner that the first qudit and the second qudit are entangled with each other. The first node 301 may be configured for subsequently transmitting 312, 313 the entangled qudits (i.e. the first qudit and the second qudit) to the second node Alice 302 and the second node Bob 303 respectively.

Advantageously, from the perspective of first node 301, this may suffice, in the sense that first node 301 need not await reception of any heralding acknowledgements, because, if generating qudits is cheap enough for the first node 301, it can simply keep on generating entangled qudits and transmitting those to the other nodes. As will be clear from this, a benefit of this embodiment may be that multiple qudit entangled pairs can be transmitted from the relay station without the need to wait for heralding signals.

If generating qudits (or transmitting them) would be too expensive to neglect, then first node 301 could of course be further developed to include a local memory, just like the other nodes described above-in that case, first node 301 could for example interfere both the first qudit and the second qudit with the local memory and could then operate analogously to first node 101 in FIG. 1, with Alice and Bob in FIG. 3 serving as second node Bob 102 according to FIG. 1.

Various embodiments according to the present disclosure may be applied for the distribution of multiple quantum-entangled pairs between two separate qubit registers, which exploits the use of high-dimensional photonic qudit states. Specifically, a single photonic time-bin qudit in dimension d=2^{m} may allow for the heralded and simultaneous generation of m entangled pairs between two distant multi-qubit registers, each containing m qubits. Photonic qudit encodings have previously been considered for quantum networks and quantum repeaters due to their higher information capacity, which can lead to higher loss tolerance and more efficient quantum key generation. By adopting the photonic qudit states, the required coherence time of the qubit memories can be made independent of the transmission probability and may amount only to the time of a single entanglement generation attempt. Furthermore, the rate of entanglement generation may be more robust to transmission loss between the distant registers than the qubit approaches.

Various embodiments according to the present disclosure may be applied to open up new opportunities for the generation of multiple high-fidelity entangled qubit pairs in an extended quantum network, where transmission loss between the nodes becomes a limiting factor both on generation rate and quantum memory requirements.

In the following description, a specific example according to the present disclosure will be described in more detail.

In a first step, the qudit photon source may generate a photonic time-bin qudit in the equal superposition across 2^{m} modes as described by the state:

$${{\vert ψ 〉}_{ph} = \frac{1}{2} {\sum }_{l = 0}^{{2}^{m} - 1} \vert l 〉}_{ph} , \qquad ( 1 )$$

where |l [symbol] ₚₕ denotes the state where the photon is located in the l′th time-bin. The photon state |ψ [symbol] ₚₕ may then interact with the first m-qubit register (Alice) initialized at |0 [symbol] \hat{ }(⊗m)—the notation “\hat{ }(X)” is used here to indicate superscript of X—in the following way: If the photon is in time-bin state |l [symbol] where the binary representation of decimal value l is [l]₁₀=[lₘ₋₁lₘ₋₂ . . . l₀]₂, the photon may interact with qubit i and flip it from 0 to 1 when lᵢ=1. Specifically, these operations can be achieved by photon-spin controlled NOT (CNOT) operations, where the photonic qudit may act as the controller and the spin qubit acts as the target. Cavity-based scattering gates can serve this function, and one can entangle the unary photonic qudit encoding with the binary spin-qubit encoding. In such a way, each photon basis state can create a unique m-qubit basis state in Alice's register:

$${{{{\vert l 〉}_{ph} ⊗ \vert 0 〉}_{A}^{⊗ m} \to \vert l 〉}_{ph} ⊗ \vert {\tilde{1}}_{l} 〉}_{A} , \qquad ( 2 )$$

$$wherein$$

$${\vert {\tilde{1}}_{l} 〉}_{A} = \vert {l}_{m - 1} 〉 \vert {l}_{m - 2} 〉 … \vert {l}_{1} 〉 \vert {l}_{0} 〉$$

Therefore, the collective state after the photon |ψ [symbol] ₚₕ interacting with Alice's register is given by:

$${{\vert {Ψ}_{1} 〉 = \frac{1}{{2}^{m / 2}} {\sum }_{l = 0}^{{2}^{m} - 1} \vert l 〉}_{ph} \vert {\tilde{1}}_{l} 〉}_{A} , \qquad ( 4 )$$

and the 2^{m} dimensional time-bin photon has been fully entangled with a m-qubit register. In the next step, the time-bin photonic qudit may be sent to another distant register (Bob) by means of direct transmission. In practice, the most probable case is that the photon gets lost during the transmission because of the exponential transmission scaling in optical fibers. For convenience, the following discussion may assume that the photon has successfully arrived to Bob, but of course provisions may be made for failures in the communication. For example, at the first node, if no heralding acknowledgement is received from the second node within a predetermined timeframe, it may be attempted to distribute a plurality of quantum-entangled pairs anew. Additionally or alternatively, at the second node, if the qudit or the other qudit has failed to be entangled with the second memory, a failure notification may be transmitted to the first node or the fourth node, triggering the first node or the fourth node to attempt distributing a plurality of quantum-entangled pairs anew.

After receiving the photonic qudit from Alice, Bob may let the photon interact with his m-qubit register in the same way as Alice. The result state after interaction may thus be:

$${{{\vert {Ψ}_{2} 〉 = \frac{1}{{2}^{m / 2}} {\sum }_{l = 0}^{{2}^{m} - 1} \vert l 〉}_{ph} \vert {\tilde{1}}_{l} 〉}_{A} \vert {\tilde{1}}_{l} 〉}_{B} , \qquad ( 5 )$$

$$wherein$$

$${\vert {\tilde{1}}_{l} 〉}_{B} = \vert {l}_{m - 1} 〉 \vert {l}_{m - 2} 〉 … \vert {l}_{1} 〉 \vert {l}_{0} 〉$$

denotes the state of Bob's register. However, Bob may have no information regarding whether the photon has indeed been transmitted to him and interacted with his register, and a heralding measurement for the time-bin photonic qudit may therefore be necessary for high-fidelity entanglement generation. The measurement should confirm the arrival of the photon without extracting its time-bin information to avoid collapsing the state of the two m-qubit registers. To fulfill this requirement, Bob can perform a generalized X-basis measurement on the photonic qudit, which amounts to projecting the photon state on to the time-bin Fourier basis states:

$${{\vert {ϕ}_{l} 〉}_{ph} = \frac{1}{\sqrt{{2}^{m}}} {\sum }_{k = 0}^{{2}^{m} - 1} {e}^{2 i π kl / {2}^{m}} \vert k 〉}_{ph} , \qquad ( 6 )$$

where l=0, 1, . . . , 2^{m}−1. The measurement setup can be implemented using optical switches (which have the benefit of being physically small) and linear optics. Successfully detecting the photonic qudit in any of the Fourier basis states may herald the entangling operation and prepare the two qubit registers in state:

$${{{{{{{\frac{1}{{2}^{m / 2}} {\sum }_{k = 0}^{{2}^{m} - 1} \vert {\tilde{1}}_{l} 〉}_{A} \vert {\tilde{1}}_{l} 〉}_{B} = \frac{1}{{2}^{m / 2}} ( \vert 0 〉}_{A} \vert 0 〉}_{B} + \vert 1 〉}_{A} \vert 1 〉}_{B} )}^{⊗ m} \qquad ( 7 )$$

up to single-qubit phase corrections dependent on the measurement outcome. Thus, Alice and Bob can create m entangled qubit pairs by only transmitting a single photonic qudit between them.

In a preferred embodiment, the multiple entangled pairs may be created simultaneously (i.e. at the same time notwithstanding that there may be minor clock synchronization differences, or within some limited time from each other), and the minimal required coherence time of the spin qubits in the registers may only depend on the time of a single entanglement attempt. For distant registers in an extended quantum network, this may be determined by the signaling time between the registers. Furthermore, assuming an overall transmission probability of n between the two qubit registers, the entanglement generation rate of the protocol may scale as n since only one single photon is transmitted.

Various embodiments according to the present disclosure may be compared to a conventional qubit approach where entanglement between two m-qubit registers would be attempted in parallel. In such an approach, spin-photon entanglement would be generated separately for each of the spin qubits in the qubit register. For applications that require the presence of all entangled pairs before execution such as the teleportation of a logical qubit composed by multiple physical qubits or entanglement purification protocols successful pairs need to be stored while waiting for the remaining pairs to succeed. Otherwise, simultaneous success in all qubit links would be necessary, and the success probability will scale as nm, causing an impractical rate for entanglement generation. Storing all successful pairs leads to a necessary coherence time of the qubits that scales as 1/η while the rate would scale as (approximately) (⅔)^{log(m)}η for η<<1. Compared with such a conventional qubit-based protocol, various embodiments according to the present disclosure may remove the unfavorable scaling of the memory time with η (t₀ vs. t₀/η), and may offer a rate that is more robust to transmission loss in terms of scaling with m (η vs. (⅔)^{log(m)}η). However, note that the local photon loss at the nodes can be different for the qubit and qudit approach depending on the specific implementation.

For a specific example, the interaction between the photonic qudit and an m-qubit register may be represented as follows. The m-qubit register may be initialized at |0 [symbol] \hat{ }(⊗m). If the photonic qudit is in state |i [symbol] (i=0, 1, . . . , 2^{m} 1) and the decimal value of i can be represented in binary [i]₁₀=[iₘ₋₁ . . . iₖ . . . i₁i₀]₂, the photonic qudit may flip the n qudit register to state |iₘ₋₁ . . . iₖ . . . i₁i₀ [symbol] .

With regards to practical implementations, the entangling operation between the photonic qudit and multiple spin-qubits can lead to correlated errors across the entangled qubit pairs that would not necessarily be present for parallel qubit approaches.

Consider a specific example implementation of embodiments according to the present disclosure, based on single quantum emitters such as neutral atoms or diamond defect centers coupled to optical resonators. In particular, the photon-induced atomic phase gates may be exploited, based on single-sided cavities with a strongly coupled emitter. The same system can also be used to generate high-dimensional photonic time-bin qudits by means of a pulsed, cavity assisted Raman scheme. Note that implementations with a single quantum emitter coupled to a small qubit register could also be envisioned as discussed below.

In the first step, a photonic qudit may be generated by a pulsed driving of a cavity-assisted Raman transition. Control of the driving power allows to tailor the amplitudes in the qudit state. This helps for the specific implementation considered in this example since the photon may experience different loss depending on which time-bin it is emitted due to e.g. non-perfect interaction with a different number of spin-cavity systems in the spin-photon entangling step. For an initially even amplitude state (see Eq. (1)), this would decrease the fidelity of the entangled pairs at the end of the protocol.

However, the uneven loss may be compensated by generating a qudit state with uneven amplitudes in such a way that the time-bin experiencing the most loss initially has the highest amplitude. This allows to move the effect from decreasing the fidelity to a modest decrease in rate.

Dominant imperfections in the qudit generation step may amount to finite spin coherence time of the emitter, imperfect pulse shaping of the driving laser, spontaneous emission from the excited state, and general photon loss (e.g. from absorption/material scattering). The latter may simply decrease the rate of the protocol given that no photon will be detected in the heralding step. The other imperfections may in general lead to an effective dephasing of the photonic qudit state due to leak of information to the environment about the emission time. Furthermore, imperfect driving may also lead to errors in the amplitude shaping of the qudit state. The effect of such imperfections may be modelled as a general dephasing channel together with random modulation of the qudit state amplitudes.

In the second step of the protocol, optical switches may be used to route the photon to the spin-cavity systems corresponding the binary encoding of the time-bins. The imperfections of the switches may be modelled as consisting of both general loss and wrong switching The spin qubits may be initialized in the state |+ [symbol] =(|0 [symbol] +|1 [symbol] )/√2 and ideally only the state |1 [symbol] may be coupled to an excited state, |e₁ [symbol] , by the cavity field. However, for systems such as SiV defect centers and quantum dots, the state |0 [symbol] would also be coupled off-resonantly by the cavity field to another excited state, |e₀ [symbol] . By tuning the frequency of the incoming photon and the cavity w.r.t. to the optical spin transitions it is, however, possible to realize a high-fidelity controlled phase gate where an incoming photon will flip the atomic state from |+ [symbol] →|− [symbol] . The combination of the switches and the spin-photon gates, followed by Hadamard gates to rotate atomic state to Z basis, may lead to the generation of the photon-spin entangled state in Eq. (4) in the ideal case.

The gate may ultimately be limited by the optical splitting between the |0 [symbol] ↔|e₀ [symbol] and |1 [symbol] ↔|e₁ [symbol] transitions, finite cooperativity of the emitter-cavity system, spectral width of the photon, and cavity loss assuming that the emitters and cavities can be tuned into the specific resonance conditions.

After transmission to the second register, a similar system of optical switches and spin-cavity systems may be used to create the state in Eq. (5) in the ideal case. As detailed above, the protocol may be heralded by the generalized X-basis measurement of the qudit state. As described above, this can be implemented using optical switches and linear optics. In particular, the switches may be used to convert the time-bin encoding into a spatial encoding, where delay lines are used to ensure temporal coincidence. The quantum Fourier transform can then be implemented by means of a beam splitter circuit, and the photon may finally be detected with single photon detectors. Notably, the physical resources of the detection step such as number of switches, beam splitters and detectors may scale linearly with the dimension of the photonic qudit. For high-dimensional qudits, probabilistic implementations using linear optics or deterministic approaches based on atomic absorption can be used to circumvent this to make the physical resources independent of the qudit dimension.

In the detection step, imperfect switches may be modelled as in the entangling steps of the protocol. Notably, both loss and wrong switching may lead to detectable errors. The former is due to the absence of a detection and the latter is due to a wrongly timed detection. Furthermore, loss in the delay lines may be modelled, which loss leads to a decrease in rate and not fidelity when balanced correctly in the qudit generation step. Finally, phase fluctuations in the beam splitters and optical paths may be modelled as a general dephasing channel on the qudit state, where the dephasing parameter scales with the dimension of the system m. Note that the general dephasing channel can also incorporate other phase errors stemmed from e.g. phase instability in optical paths or additional phase fluctuation in photon source.

In general, quantum entanglement is an important resource in quantum information processing. It is a kind of special quantum state in the multi-particle complex system. Entanglement sources in quantum entanglement may include photons, electrons, ions and the like. Due to the relatively good coherence of photons, entangled photons have become the common source of quantum entanglement. Photons have different degrees of freedom, for example, degree of freedom of polarization, degree of freedom of path, degree of freedom of angular momentum, etc. Each degree of freedom can be used to encode information. However, various embodiments according to the present disclosure are not intended to be limited to photon implementations only, as the principles of the present disclosure may be applicable for all non-reliable fields of quantum generation.

The technology for generating quantum-entangled photon pairs may be used for implementing quantum information and communication systems, such as quantum cryptography and quantum computers, in which the quantum-mechanical behavior of light, or photons, is utilized. In particular, the quantum key delivery technology utilizing quantum-entangled photon pairs can expect an application to secure encryption communication. In this context, the quantum-mechanical behavior means a behavior in accordance with the superposition principle or the like that several different states can be taken at the same time.

As for the quantum-entangled photon pairs to be utilized for quantum key distribution, polarization-entangled photon pairs and time-bin entangled photon pairs have predominantly been studied so far. The former is presented by, for example, H. C. Lim, et al., “Stable source of high quality telecom-band polarization-entangled photon pairs based on a single, pulse-pumped, short PPLN waveguide”, Optics Express, vol. 16, No. 17, pp. 12460-12468 (2008). The latter is disclosed by, for example, J. F. Dynes, et al., “Efficient entanglement distribution over 200 kilometers”, Optics Express, vol. 17, No. 14, pp. 11440-11449 (2009).

Polarization-entangled photon pairs are photon pairs in which the polarizations of individual photons are not determined but the relationship of the polarizations measured is determined, such as parallel or orthogonal to each other. That is, polarization-entangled photon pairs are in a state where a photon pair has its plural polarizations in combination superposed to each other and the polarizations are correlated between photon pairs.

Time-bin entangled photon pairs, considering two time slots to be observed in which photons in pair may possibly exist, are photon pairs in which it is not determined in which time slot individual photons exist but is determined the relationship of measurement results in which two photons definitely exist in one and the same time slot. That is, time-bin entangled photon pairs are in a state where photons in pair are distributed to plural time slots for the photon pair to overlap with each other and the photon pairs are correlated in temporal position therebetween.

As a transmission medium of quantum-entangled photon pairs, optical fiber can be used. If optical fiber is used as a transmission medium, it is possible to lengthen a quantum key delivery distance due to the lower transmission loss of the optical fiber.

It is noted in general that the memory state of the first/second memory may be maintained after entangling the qudit at least until the heralding acknowledgement is received, in accordance with a coherence time of the first/second memory, and depending on a quantum implementation of the first/second memory, and, in the ideal case, even independent of a transmission probability of transmitting the qudit.

1. A method for distributing a plurality of quantum-entangled pairs between a plurality of nodes in a communication network; the method comprising, at a first node of the plurality of nodes:
generating a qudit of dimension 2^{m}, m being an integer greater than 1, in such a manner that the qudit is entangled with a first memory at the first node;
transmitting the entangled qudit to a second node of the plurality of nodes; and
receiving a heralding acknowledgement from the second node that the transmitted qudit has been entangled with a second memory at the second node;
wherein a memory state of the first memory is maintained after entangling the qudit at least until the heralding acknowledgement is received.

2. A method for distributing a plurality of quantum-entangled pairs between a plurality of nodes in a communication network; the method comprising, at a second node of the plurality of nodes:
obtaining a qudit of dimension 2^{m}, m being an integer greater than 1, wherein the qudit has been generated by a first node of the plurality of nodes;
entangling the qudit with a second memory at the second node; and
transmitting a heralding acknowledgement to a third node of the plurality of nodes or to the first node that the obtained qudit has been entangled with the second memory;
wherein a memory state of the second memory is maintained after entangling the qudit at least until the heralding acknowledgement is received.

3. The method of claim 2, for distributing the plurality of quantum-entangled pairs between the plurality of nodes in the communication network; wherein the qudit has been entangled with a first memory at the first node of the plurality of nodes; and wherein the heralding acknowledgement is transmitted to the first node.

4. The method of claim 3, comprising, at the second node:
obtaining another qudit of dimension 2^{m}, m being an integer greater than 1, wherein the other qudit has been entangled with a fourth memory at a fourth node of the plurality of nodes;
entangling the other qudit with the second memory; and
transmitting another heralding acknowledgement to the fourth node that the obtained other qudit has been entangled with the second memory;
wherein the memory state of the second memory is maintained after entangling the other qudit at least until the other heralding acknowledgement is received.

5. The method of claim 1, wherein the first memory and the second memory each comprise a memory register of m qubits.

6. The method of claim 1, comprising:
at the first node, if no heralding acknowledgement is received from the second node within a predetermined timeframe, attempting to distribute a plurality of quantum-entangled pairs anew; and/or
at the second node, if the qudit or the other qudit has failed to be entangled with the second memory, transmitting a failure notification to the first node or the fourth node, triggering the first node or the fourth node to attempt distributing a plurality of quantum-entangled pairs anew.

7. The method of claim 1, wherein the qudit is a quantum particle selected from the following: a photon; an electron; an ion; and a phonon; and wherein the qudit is preferably a photon.

8. The method of claim 1, wherein entangling the qudit with a memory comprises time-bin encoding the qudit in m time-bins; and wherein the step of time-bin encoding the qudit in m time-bins preferably comprises routing the qudit, being a photon, via a plurality of optical switches, to a corresponding plurality of spin-cavity systems corresponding with a desired binary encoding of the time-bins.

9. The method of claim 1, wherein the qudit is a photon and wherein the qudit is generated using at least one single quantum emitter coupled to at least one optical resonator.

10. The method of claim 1, wherein the qudit is a photon and wherein the qudit is generated by means of a pulsed, cavity-assisted Raman scheme.

11. The method of claim 1, wherein the method is executed as computer program instructions stored in a non-transitory computer readable medium and executed by at least one processor of a node of a communication network.

12. A first node in a communication network containing a plurality of nodes, for distributing a plurality of quantum-entangled pairs between the plurality of nodes; the first node comprising:
a first memory;
a qudit generator configured for generating a qudit of dimension 2^{m}, m being an integer greater than 1, in such a manner that the qudit is entangled with the first memory;
a qudit transmitter configured for transmitting the entangled qudit to a second node of the plurality of nodes; and
a receiver configured for receiving a heralding acknowledgement from the second node that the transmitted qudit has been entangled with a second memory at the second node;
wherein the first memory is configured to maintain its memory state after entangling the qudit at least until the heralding acknowledgement is received.

13. A second node in a communication network containing a plurality of nodes, for distributing a plurality of quantum-entangled pairs between the plurality of nodes; the second node comprising:
a qudit receiver configured for obtaining a qudit of dimension 2^{m}, m being an integer greater than 1, wherein the qudit has been generated by a first node of the plurality of nodes;
a qudit entangler configured for entangling the qudit with a second memory at the second node; and
a transmitter configured for transmitting a heralding acknowledgement to a third node of the plurality of nodes or to the first node that the obtained qudit has been entangled with the second memory;
wherein the second memory is configured to maintain its memory state after entangling the qudit at least until the heralding acknowledgement is received.

14. The second node of claim 13, for distributing the plurality of quantum-entangled pairs between the plurality of nodes in the communication network; wherein the qudit has been entangled with a first memory at the first node of the plurality of nodes; and wherein the transmitter is configured for transmitting the heralding acknowledgement to the first node.

15. The second node of claim 14,
wherein the qudit receiver is configured for obtaining another qudit of dimension 2^{m}, m being an integer greater than 1, wherein the other qudit has been entangled with a fourth memory at a fourth node of the plurality of nodes;
wherein the qudit entangler is configured for entangling the other qudit with the second memory;
wherein the transmitter is configured for transmitting another heralding acknowledgement to the fourth node that the obtained other qudit has been entangled with the second memory; and
wherein the second memory is configured to maintain its memory state after entangling the other qudit at least until the other heralding acknowledgement is received.
